(19) United States
(12) Patent Application Publication
(10) Pub. No.: US 2017/0205272 A1
(43) Pub. Date: Jul. 20, 2017

(54) LOAD CELL, WEIGHING NETWORK AND MONITORING METHOD

(71) Applicants: Mettler Toledo (Changzhou) Precision Instrument Ltd., Changzhou (CN); Mettler Toledo (Changzhou) Measurement Technology Ltd., Changzhou (CN); Mettler Toledo (Changzhou) Scale & System Ltd., Changzhou (CN)

(72) Inventors: Ying Zhang, Changzhou (CN); Jianwei Wu, Changzhou (CN); Wei Wang, Changzhou (CN); Fenglian Wen, Changzhou (CN); Zhitie Lin, Changzhou (CN)

(21) Appl. No.: 15/479,383

(22) Filed: Apr. 5, 2017

Related U.S. Application Data
(63) Continuation of application No. PCT/CN2015/091554, filed on Oct. 9, 2015.

(30) Foreign Application Priority Data
Oct. 9, 2014 (CN) 201410529715.6

(51) Int. Cl. G01G 3/14; G01L 1/22; G01B 7/16

(52) U.S. Cl. CPC G01G 3/14; G01B 7/20; G01L 1/225

(57) ABSTRACT

A load cell has four resistive strain gauges, a digital-to-analog conversion circuit and a signal processor. The signal processor can output a real-time load stress value Fₙ and a real-time state information matrix Sₜ. A weighing network is made of a load cell array composed of a plurality of the load cells, a collection device for collecting external information, and a control terminal. Further proposed in the present invention is a monitoring method for a weighing network, applied to the aforementioned weighing network, wherein the control terminal collects real-time external information, and a real-time load stress value Fₙ and a real-time state information matrix Sₜ for each load cell in real time; and compares the real-time external information, and the real-time load stress value Fₙ and the real-time state information matrix Sₜ for each load cell with data stored in a weighing process database to monitor the state of the weighing network.

### CROSS-REFERENCE TO RELATED APPLICATIONS

This application is a bypass continuation of PCT application PCT/CN2015/091554, filed 9 Oct. 2015, which, in turn, claims priority to Chinese patent application 201410529715.6, filed on 9 Oct. 2014. The content of each of these applications is incorporated by reference as if fully recited herein.

### TECHNICAL FIELD

The disclosed embodiments relate to the technical field of monitoring and diagnosing, and in particular to a weighing network based on digital sensors and a monitoring method therefor.

### BACKGROUND

In modern industrial production procedures, weight information has always become a key information source and control target. For example, in vehicle weigh systems, weight information is the final output data required. In filling lines, weight information becomes the control target of filling production procedures. Therefore, the reliability and precision of weighing are of great significance.

With the development of digitalization and information technology, the traditional weighing systems start to step into a digital weighing system era. A circuit with a high accuracy analog-to-digital conversion function and digital processing capability is built in a sensor to convert load stress information about the sensor into a digital signal. One or more digital load cells interact data and instructions with terminal devices such as an instrument and an industrial personal computer in a wired of wireless communication manner to form a weighing communication topology network together to send formatted weighing data to the terminal devices such as the instrument and the industrial personal computer for final processing and display.

In existing digital weighing systems, terminal devices such as an instrument and an industrial personal computer are the core of data processing, which process data received from the digital load cell into weighing data of the weighing system. In the meantime, overload information, temperature data and calibration information about a digital sensor node are recorded. However, important information such as the complicated usage process, network health conditions, service life and weight element states of the digital weighing system cannot be monitored, analysed and diagnosed. With the increasing of the service time of the digital weighing system, some failures and problems of the load cell may unavoidably appear, which makes the state of the sensor unstable and the reliability and precision reduced. Since the digital weighing system is composed of various digital sensors, the problem of a digital load cell may result in reduced reliability and precision of the entire digital weighing system.

In the prior art, it is unable to effectively monitor and diagnose the running conditions of the digital weighing system itself

### SUMMARY

The present invention is intended to propose a method capable of monitoring a weighing network composed of digital load cells, and a corresponding weighing network and a load cell thereof.

According to an embodiment of the present invention, a load cell is proposed, comprising: four strain gauges, a digital-to-analog conversion circuit and a signal processor.

The four strain gauges comprise a first strain gauge SG1, a second strain gauge SG2, a third strain gauge SG3 and a fourth strain gauge SG4, the four strain gauges being mounted on a surface of a sensor elastomer and located in a force measurement region of the sensor elastomer, and the four strain gauges being connected to form a Wheatstone bridge and then form a strain bridge with a temperature sensing element.

A digital-to-analog conversion circuit contains a reference voltage end (Vref), a grounding end (GND), a plurality of input channels and a digital output end (Dout), the digital-to-analog conversion circuit incenting the strain bridge via the reference voltage end (Vref) and the grounding end (GND), and receiving feedback signals of the strain bridge respectively via the plurality of input channels, and the feedback signals being output via the digital output end (Dout).

A signal processor receives the feedback signals from the output end Dout of the digital-to-analog conversion circuit, and the signal processor comprises a load stress calculation unit and a state information matrix calculation unit, the load stress calculation unit obtaining a load stress value through calculation according to the feedback signals, and the state information matrix calculation unit obtaining a state information matrix through calculation according to the feedback signals.

In one embodiment, the plurality of input channels comprise a first input channel (CH1), a second input channel (CH2) and a third input channel (CH3). The reference voltage end (Vref) outputs a high voltage Vₑ₊, the grounding end (GND) outputs a low voltage Vₑ₋, and incentive voltages (Vₑ₊,Vₑ₋) are applied to the ends of the strain bridge. A first feedback signal V_{BG} is drawn out between the temperature sensing element and the Wheatstone bridge, and the first feedback signal V_{BG} is input to the first input channel CH1. A second feedback signal V_{SP} is drawn out between the first strain gauge SG1 and the second strain gauge SG2, and the second feedback signal V_{SP} is input to the second input channel CH2. A third feedback signal V_{SN} is drawn out between the third strain gauge SG3 and the fourth strain gauge SG4, and the third feedback signal V_{SN} is input to the third input channel CH3.

In one embodiment, the load stress calculation unit calculates a differential voltage V_{S}=V_{SP}−V_{SN} according to the second feedback signal V_{SP} and the third feedback signal V_{SN}, calculates a compensation function f(V_{BG}, V_{SP}, V_{SN}) according to the first feedback signal V_{BG}, the second feedback signal V_{SP}and the third feedback signal V_{SN}, and obtains a load stress value Fₙ=(V_{SP}−V_{SN})*K+f(V_{BG}, V_{SP}, V_{SN}) through calculation according to the differential voltage and the compensation function, where K is a strain force coefficient constant of the sensor.

In one embodiment, the state information matrix calculation unit calculates real-time voltage values of the four strain gauges according to the first feedback signal V_{BG}, the second feedback signal V_{SP} and the third feedback signal V_{SN}, and further obtains a state information matrix Sₜ=Matrix(V_{SP}, V_{SN}, V_{BG}, Fₙ) through calculation according to the real-time voltage values and the load stress value Fₙ.

In one embodiment, a state information matrix threshold database is further comprised, the state information matrix threshold database storing state information matrix thresholds S_{TH} corresponding to different sensor application states, and comparing the state information matrix Sₜ with the state information matrix thresholds S_{TH} to obtain failure information. In the meantime, the current state of the sensor is detected according to the load stress value Fₙ and the state information matrix Sₜ, and the deviation generated due to the current state of the sensor is corrected.

According to one embodiment of the present invention, a weighing network is proposed, comprising: a load cell array, a collection device and a control terminal. The load cell array comprises several aforementioned load cells. The collection device collects external information about the load cell array. The control terminal connects to each load cell in the load cell array via a power cable and a signal cable, and the control terminal supplies power to the load cells in the load cell array via the power cable and receives signals of the load cells via the signal cable. The control terminal comprises a cable monitoring unit, the cable monitoring unit detecting the current and impedance on the power cable, a cable monitoring unit detecting the voltage and impedance on the signal cable, and the control terminal determining the states of the power cable and the signal cable based on the external information collected by the collection device and a detection signal of the cable monitoring unit.

In one embodiment, the signals of the load cells received by the control terminal via the signal cable comprise a load stress value Fₙ and a state information matrix Sₜ for each load cell.

In one embodiment, the external information comprises an arrangement position, the type of a weighted object and time information for each load cell in the load cell array. The control terminal establishes a weighing process database in combination with the external information, and the load stress value Fₙ and the state information matrix Sₜ for each load cell.

According to one embodiment of the present invention, a monitoring method for a weighing network is proposed, applied to the aforementioned weighing network, wherein the control terminal collects real-time external information, and a real-time load stress value Fₙ and a real-time state information matrix Sₜ for each load cell in real time; and compares the real-time external information, and the real-time load stress value Fₙ and the real-time state information matrix Sₜ for each load cell with data stored in a weighing process database to monitor the state of the weighing network.

The load cell, weighing network and monitoring method of the present invention can monitor and analyze information such as the load state, usage process, health conditions and service life of a weighing network composed of digital load cells, and diagnose, analyze and record information such as the network state, node information and communication conditions of the weighing system, thereby ensuring the reliability and precision of the weighing system.

### BRIEF DESCRIPTION OF THE DRAWINGS

In order to make the above objectives, features and advantages of the present invention more apparent and easier to be understood, the specific embodiments of the present invention are described in detail below in conjunction with the accompanying drawings, in the drawings:

FIG. 1 is a schematic diagram of a load cell according to one embodiment of the present invention; and

FIG. 2 is a schematic diagram of a weighing network according to one embodiment of the present invention.

### DETAILED DESCRIPTION

The objective of the present invention is to improve the reliability of a weighing system based on digital load cells, and ensure the precision thereof. Proposed in the present invention is a digital load cell, a weighing network composed of the digital load cell, and a monitoring method for the weighing network. By virtue of software and hardware resources integrated inside the digital load cell and a control terminal and in combination of load stress analysis techniques of the sensor, various intelligent digital diagnosis techniques are used comprehensively to monitor and analyze information such as the load stress state, weighing element state and service life of a digital load cell node and monitor, analyze, diagnose and record information such as the usage process, network state and communication conditions of the weighing system.

The basic design idea of the present invention is as follows: a resistive strain gauge is firmly adhered on a force measurement region of a load cell, and a micro strain is generated on the force measurement region when the sensor is loaded, and then the strain gauge is deformed therewith and the resistance changes regularly; according to the principle of Wheatstone bridge, the strain gauges are connected and are driven by utilizing a voltage source, thereby converting load stress of the sensor into a differential voltage signal to be output; the output differential voltage signal is filtered, amplified and analog-to-digital converted, and is converted into weighing information; and in the meantime, analog-to-digital conversion is performed respectively on relevant voltage signals to obtain weighing element state information. After being designed and manufactured according to a certain principle, the load cell has a good repeatability, which ensures the consistency among sensor load information, weighing data information and weighing element state information. The consistency between the sensor load information and weighing data information ensures that the digitalized weighing data can truly reflect the load stress conditions of the sensor; and because of the existence of consistency between the weighing data information and weighing element state information, data of the two is detected by utilizing a digital algorithm and compared with preset thresholds, then real-time state information about the load cell can be obtained, for example, whether a failure such as short-circuit or open-circuit occurs to the bridge composed of strain gauges, whether a failure such as short-circuit or open-circuit occurs to a Ni—Pt resistor which is used as a temperature sensing element, whether asymmetry of strain gauge output due to various factors such as mechanical damage and overload fatigue exists on the sensor.

In the meantime, utilizing the real-time state information about the load cell can correct the deviation of weighing data resulted from the current state, such as slant correction and angle difference correction of the sensor.

In the usage process of the weighing system, the digital load cell converts the applied load into weighing data, and sends same to a control terminal such as an instrument or an industrial personal computer in the form of formatted data. In this process, in combination of multi-dimensional state information such as time and a weighted object type provided by a terminal device such as an instrument or an industrial personal computer, the present invention monitors and analyzes the usage process of the weighing system, such as overload moment recording of the sensor, effective weighing times recording of the sensor, time, frequency and total quantity of the weighted object type and other information. Utilizing the overload moment information about the sensor can provide a recording result when there is a failure caused by sensor overload; utilizing the effective weighing times recording of the sensor in combination with a weighing element state and service life algorithm on the basis of a fatigue limit theory and experimental data provides service life state information about a sensor node, and gives pre-warning information when the end of the fatigue service life approaches; and Utilizing time, frequency and total quantity information about the weighted object type summarizes and analyzes the weighing moment, frequency, weight level, overload times and total quantity of weighing and other information about different weighing object types, thereby acquiring important information about a system user usage process.

The digital load cell needs to construct a certain communication topology network via a wired or wireless medium to send weighing data to a control terminal such as an instrument or an industrial personal computer, and the communication topology network has become a significant constituent part of the weighing system. The present invention monitors voltage signals communicated on a physical layer on a control terminal such as an instrument or an industrial personal computer and a digital load cell. On a control terminal such as an instrument or an industrial personal computer, important information such as instantaneity, retransmission times and error code number about communication data transmission is monitored and analyzed, and the acquired voltage information and data characteristic information is analyzed via a digital algorithm based on the network communication principle and specific applications to acquire state information about the communication system so as to perform state diagnosis and pre-warning prompt.

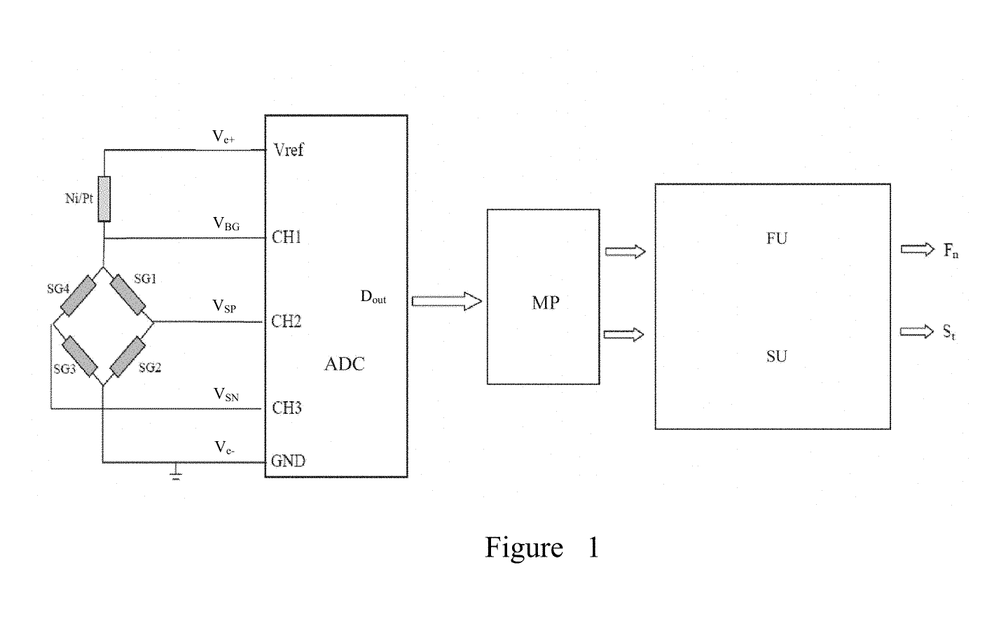

The basic unit of the present invention is a digital load cell. FIG. 1 is a schematic diagram of a load cell according to one embodiment of the present invention. The load cell 100 comprises: four resistive strain gauges, comprising a first strain gauge SG1, a second strain gauge SG2, a third strain gauge SG3 and a fourth strain gauge SG4, the four resistive strain gauges being mounted on a surface of a sensor elastomer and located in a force measurement region of the sensor elastomer. The resistance value of the resistive strain gauge changes with the deformation after the elastomer is loaded, and the resistance value changes symmetrically. The four resistive strain gauges are connected to form a Wheatstone bridge, and the Wheatstone bridge is then connected to a temperature sensing element in series to form a strain bridge. In the embodiment shown in this figure, the temperature sensing element is a Ni—Pt resistor Ni/Pt.

The digital-to-analog ADC conversion circuit comprises a reference voltage end Vref, a grounding end GND, a first input channel CH1, a second input channel CH2, a third input channel CH3 and an output end Dout. The digital-to-analog ADC conversion circuit incents the strain bridge via the reference voltage end Vref and the grounding end GND, and receives feedback signals of the strain bridge via the first input channel CH1, the second input channel CH2 and the third input channel CH3, and the feedback signals are output via the output end Dout. In the embodiment shown in FIG. 1, the reference voltage end (Vref) outputs a high voltage Vₑ₊, the grounding end (GND) outputs a low voltage Vₑ₋, and incentive voltages (Vₑ₊,Vₑ₋) are applied to the ends of the strain bridge, i.e., the Wheatstone bridge bridges the ends of the series circuit with the temperature sensing resistor Ni/Pt. A first feedback signal V_{BG} is drawn out between the temperature sensing resistor Ni/Pt and the Wheatstone bridge, and the first feedback signal V_{BG} is input to the first input channel CH1. A second feedback signal V_{SP} is drawn out between the first strain gauge SG1 and the second strain gauge SG2, and the second feedback signal V_{SP} is input to the second input channel CH2. A third feedback signal V_{SN} is drawn out between the third strain gauge SG3 and the fourth strain gauge SG4, and the third feedback signal V_{SN} is input to the third input channel CH3.

A signal processor MP receives the feedback signals from the output end Dout of the digital-to-analog ADC conversion circuit, and the signal processor MP comprises a load stress calculation unit FU and a state information matrix calculation unit SU. The load stress calculation unit FU obtains a differential voltage and a compensation function according to the calculation of the feedback signals, and further obtains a load stress value through calculation according to the differential voltage and compensation function. The state information matrix calculation unit SU obtains real-time voltage values of the four resistive strain gauges through calculation according to the feedback signals, and further obtains a state information matrix according to the calculation of the real-time voltage values and the load stress value. In one embodiment, the load stress calculation unit FU calculates a differential voltage V_{S}=V_{SP}−V_{SN} according to the second feedback signal V_{SP} and the third feedback signal V_{SN}, calculates a compensation function f(V_{BG}, V_{SP}, V_{SN}) according to the first feedback signal V_{BG}, the second feedback signal V_{SP} and the third feedback signal V_{SN}, and obtains a load stress value Fₙ=(V_{SP}−V_{SN})*K+f(V_{BG}, V_{SP}, V_{SN}) through calculation according to the differential voltage and the compensation function, where K is a strain force coefficient constant of the sensor. The state information matrix calculation unit SU calculates real-time voltage values of the four resistive strain gauges according to the first feedback signal V_{BG}, the second feedback signal V_{SP} and the third feedback signal V_{SN}, and further obtains a state information matrix Sₜ=Matrix(V_{SP}, V_{SN}, V_{BG}, Fₙ) through calculation according to the real-time voltage values and the load stress value Fₙ.

The theoretical basis for the signal processor MP to process feedback signals is as follows:

the differential voltage Vₛ reflects the deformation of the strain gauge, i.e. the conditions of the load stress of the sensor elastomer.

The second feedback signal V_{BG} reflects the voltage of the Wheatstone bridge composed of the strain gauges. In the meantime, since the strain bridge is incented by a constant voltage source, V_{BG} can also reflect the voltage of the Ni/Pt resistor, thus reflecting temperature information about the sensor.

With regard to the first feedback signal V_{BG}, the second feedback signal V_{SP} and the third feedback signal V_{SN}, since one node of the Wheatstone bridge is connected to a zero potential, the arithmetical combination of the three voltages can reflect the voltages of the four strain gauges, thus reflecting state information about the weighing element.

The differential voltage V_{S} can reflect the conditions of the sensor load stress, and operation can also be conducted on V_{SP}, V_{SN} and V_{BG} via a digital algorithm at the same time to obtain the temperature of the sensor when being loaded, and factors such as a non-linear error, lag error and temperature stability error of the sensor are compensated, thus finally obtaining a true sensor load stress value: Fₙ=(V_{SP}−V_{SN})*K+f(V_{BG}, V_{SP}, V_{SN}), where K is a strain force coefficient constant of the sensor, and f(V_{BG}, V_{SP}, V_{SN}) is a digital compensation operation function.

By performing arithmetical combination operation on V_{SP}, V_{SN} and V_{BG}, real-time voltage values of four strain gauges are obtained, and in combination of multi-dimensional information such as the load stress value Fₙ and temperature information about the sensor, a state information matrix of the weighing element can be obtained: Sₜ=Matrix(V_{SP}, V_{SN}, V_{BG}, Fₙ). Because of the structure and characteristics of the sensor, there is consistency between the state information matrix and comprehensive information such as the stress actually loaded by the sensor, the temperature and the bridge state. In the sensor production process, state information matrices in different temperatures and different load conditions are recorded. A threshold S_{TH} of the state information matrix is obtained according to the specific analysis of sensor applications. In the actual application process of the sensor, comparing the state information matrix Sₜ and the threshold S_{TH} thereof can determine various failure phenomena, such as whether short-circuit or open-circuit exists on the bridge composed of strain gauges, whether short-circuit or open-circuit exists on the Ni—Pt resistor which is used as a temperature sensing element, and whether asymmetry of strain gauge output due to various factors such as mechanical damage and overload fatigue of the sensor exists, thereby achieving intelligent diagnosis of weighing element state information.

Thus, in one embodiment, the load cell may further comprise or be connected to a state information matrix threshold database, the state information matrix threshold database storing state information matrix thresholds S_{TH} corresponding to different sensor application states, and comparing the state information matrix Sₜ with the state information matrix thresholds S_{TH} to obtain failure information.

In the meantime, the current state of the sensor is detected according to the state information matrix Sₜ, and the deviation between the load stress value Fₙ and the actual load stress value generated due to the current state of the sensor is corrected.

In this example, a Ni—Pt resistor is used as the temperature sensing element. In fact, other types of temperature sensors can also be used to achieve similar functions.

In this example, the temperature sensing element is connected in series with the Wheatstone bridge composed of strain gauges to form a complete strain bridge. In fact, the temperature sensing element and the Wheatstone bridge composed of strain gauges can be incented respectively, which can also achieve a similar intelligent diagnosis function.

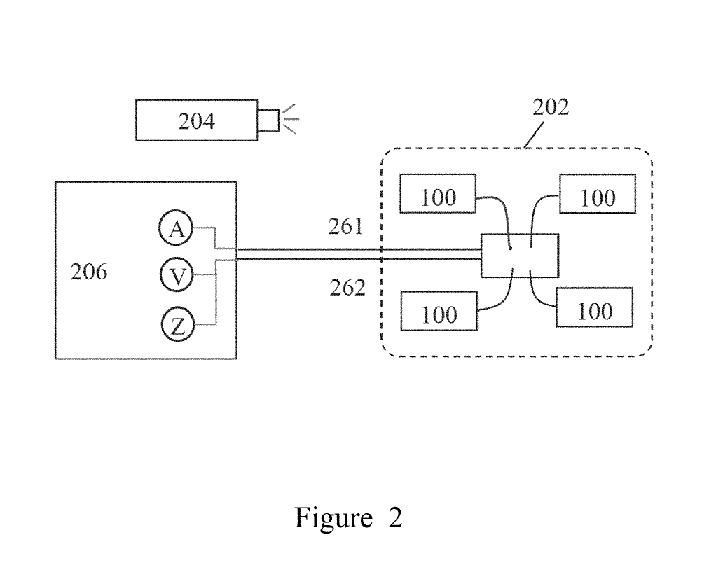

Taking the aforementioned digital load cell as a basis, proposed in the present invention is a weighing network. FIG. 2 is a schematic diagram of a weighing network according to one embodiment of the present invention. The weighing network 200 comprises: a load cell array 202, a collection device 204 and a control terminal 206.

The load cell array 202 comprises several aforementioned load cells 100. The collection device 204 collects external information about the load cell array. In one embodiment, the external information collected by the collection device comprises an arrangement position, the type of a weighted object and time information for each load cell in the load cell array. The collection device 204 mainly comprises a monitoring device and a built-in circuit. The control terminal 206 is connected to each load cell 100 in the load cell array via a power cable 261 and a signal cable 262, and the signals of the load cells received by the control terminal 206 via the signal cable comprise a load stress value Fₙ and a state information matrix Sₜ for each load cell. In one embodiment, the control terminal 206 mainly comprises an instrument and an industrial personal computer. In actual applications, when the load cells are topologically connected in a wired manner, various types of cables are generally used for connection, and in practice it is found that a number of failures are sourced from cable failures and cable connection failures. The internal core wires of the cables used by the weighing network can be respectively defined as a power cable and a data signal cable depending on usages. In order to exclude signal errors caused by cable failures or cable connection failures, in the present invention, a circuit with the objective of electrical signal detection of features such as a real-time current, impedance and amplitude value is designed in the control terminal, and by performing real-time detection on the current in the power cable and comparing same with key information such as a current threshold and the number of sensors, whether there is a failure such as damage or short-circuit in the power cable is determined and pre-warned. In general, the data signal cable interface is of high configuration, and accordingly, it makes no actual sense to directly measure the current in the signal cable. In the present invention, by testing electrical signals of features such as impedance and an amplitude value on the data signal cable in combination with information such as a communication network topology structure and the number of sensors, diagnosis and pre-warning prompt for the state of the data signal cable are achieved.

In one embodiment, the control terminal 206 supplies power to the load cells 100 in the load cell array 202 via the power cable 261 and receives signals of the load cells via the signal cable 262. The control terminal 206 comprises a cable monitoring unit, the cable monitoring unit detecting the current and impedance on the power cable 261, and a cable monitoring unit further detecting the voltage and impedance on the signal cable 262. The control terminal 206 determines the states of the power cable 261 and the signal cable 262 based on the external information collected by the collection device and a detection signal of the cable monitoring unit. The control terminal 206 establishes a weighing process database in combination with the external information, and the load stress value Fₙ and the state information matrix Sₜ for each load cell. Based on the weighing process database, the control terminal 206 can achieve the following monitoring functions:

a) according to a preset overload threshold, when the load cell is overloaded, the overloaded load and moment are recorded, and this recorded value will be stored in the load cell and sent to the control terminal for storage, so as to be used to monitor the usage conditions of the weighing network, and to provide an analysis basis when the load cell has failed.

b) According to a preset effective load threshold, the load cell records effective weighing times, and in combination with a service life algorithm on the basis of a fatigue limit theory and experimental data and taking the overload times and frequency into consideration, provides service life state information about a load cell node, and gives pre-warning information when the fatigue service life approaches.

c) The control terminal analyzes and records information such as weighing time, frequency and total quantity information about the weighted object type, summarizes and analyzes the weighing moment, frequency, weight level, overload times and total quantity of weighing and other information about different weighing object types, thereby acquiring important information about a system user usage process.

d) The installation positions of the load cells in the weighing network are different, and according to basic physics principle analysis, weighing data of each load cell is related to the installation position thereof, and thus the obtained weighing data is also different. On the premise that there is symmetry in the installation positions of the load cells, the weighing data also has numerical value symmetry determined by position symmetry. The control terminal analyzes and records weighing data and position parameters of the load cells, so as to be able to obtain the usage state conditions of the weighing network by monitoring and diagnosis.

e) The cable monitoring unit in the control terminal monitors the voltage of the signal transmitted in the signal cable in the communication cable, thereby monitoring and analyzing communication signals from a physical layer perspective, and monitoring problems such as damage, short-circuit and mistaken grounding which may exist in the signal cable network.

f) In the process where the control terminal is in communication with the digital sensor, important information such as instantaneity, retransmission times and error code number about communication data transmission is monitored and analyzed, and the acquired voltage information and data characteristic information is analyzed via a digital algorithm based on the network communication principle and specific applications to acquire state information about the communication system so as to perform state diagnosis and pre-warning prompt.

g) A cable monitoring unit is integrated inside the control terminal to perform electrical signal detection of features such as a real-time current, impedance and amplitude value, and by performing real-time detection on the current in the power cable and comparing same with key information such as a current threshold and the number of sensors, whether there is a failure such as damage or short-circuit in the power cable is determined and pre-warned; and by testing electrical signals of features such as impedance and an electrical level amplitude value on the signal cable in combination with information such as a communication network topology structure and the number of sensors, diagnosis and pre-warning prompt for the state of the data signal cable are achieved.

Further proposed is a monitoring method for a weighing network, applied to the aforementioned weighing network, wherein the control terminal collects real-time external information, and a real-time load stress value Fₙ and a real-time state information matrix Sₜ for each load cell in real time; and compares the real-time external information, and the real-time load stress value Fₙ and the real-time state information matrix Sₜ for each load cell with data stored in a weighing process database to monitor the state of the weighing network.

The functions which can be achieved by the weighing network monitoring method comprise aforementioned functions a)-g).

The load cell, weighing network and monitoring method of the present invention can monitor and analyze information such as the load state, usage process, health conditions and service life of a weighing network composed of digital load cells, and diagnose, analyze and record information such as the network state, node information and communication conditions of the weighing system, thereby ensuring the reliability and precision of the weighing system.

What is claimed is:

1. A load cell, comprising:
four strain gauges, each of which is mounted on a surface of a cell deformation part and located in a force measurement region of the cell deformation part, the four strain gauges connected to form a Wheatstone bridge and to also form a strain bridge with a temperature sensing element;
a digital-to-analog conversion chip circuit, having a reference voltage end (V_{ref}), a grounding end (GND), a plurality of input channels and a digital output end (Dₒᵤₜ), wherein the digital-to-analog conversion circuit is arranged to incent the strain bridge via the reference voltage end (Vref) and the grounding end (GND), to receive analog feedback signals of the strain bridge respectively via the plurality of input channels, and to output digital feedback signals via the digital output end (Dₒᵤₜ); and
a signal processor, arranged to receive the digital feedback signals from the output end (Dₒᵤₜ) of the digital-to-analog conversion circuit, comprising:
a load stress calculation unit, configured to calculate a load stress value from the digital feedback signals; and
a state information matrix calculation unit, configured to obtaining a state information matrix through calculation using the digital feedback signals.

2. The load cell of claim 1, wherein:
the plurality of input channels comprise a first input channel (CH1), a second input channel (CH2) and a third input channel (CH3);
the reference voltage end (Vref) outputs a high incentive voltage Vₑ₊;
the grounding end (GND) outputs a low incentive voltage Vₑ₋;
the incentive voltages (Vₑ₊,Vₑ₋) are applied to the ends of the strain bridge;
the first input channel receives as input a first feedback signal V_{BG} that is drawn out between the temperature sensing element and the Wheatstone bridge;
the second input channel receives as input a second feedback signal V_{SP} that is drawn out between a first of the four strain gauges and a second of the four strain gauges; and
the third input channel receives as input a third feedback signal V_{SN} that is drawn out between a third of the four strain gauges and a fourth of the four strain gauge.

3. The load cell of claim 2, wherein the load stress calculation unit:
calculates a differential voltage V_{S}=V_{SP}−V_{SN} according to the second feedback signal V_{SP} and the third feedback signal V_{SN};
calculates a compensation function f(V_{BG}, V_{SP}, V_{SN}) according to the first feedback signal V_{BG}, the second feedback signal V_{SP} and the third feedback signal V_{SN}; and
obtains a load stress value Fₙ=(V_{SP}−V_{SN})*K+f(V_{BG}, V_{SP}, V_{SN}) through calculation according to the differential voltage and the compensation function, where K is a strain force coefficient constant of the load cell.

4. The load cell of claim 3, wherein the state information matrix calculation unit:
calculates real-time voltage values of the four strain gauges according to the first feedback signal V_{BG}, the second feedback signal V_{SP} and the third feedback signal V_{SN}; and
obtains a state information matrix Sₜ=Matrix(V_{SP}, V_{SN}, V_{BG}, Fₙ) through calculation according to the real-time voltage values and the load stress value Fₙ.

5. The load cell according to claim 4, further comprising:
a state information matrix threshold database that stores state information matrix thresholds S_{TH} that correspond to different sensor application states, such that failure information is obtained by comparing the state information matrix Sₜ with the state information matrix thresholds S_{TH}.

6. The load cell according to claim 4, wherein the signal processor comprehensively detects the current state of the load cell, according to the state information matrix Sₜ and the load stress value Fₙ, and corrects the deviation generated due to the current state of the load cell.

7. A weighing network, comprising:
a load cell array, comprising a plurality of load cells according to claim 1;
a collection device that collects external information about the load cell array; and
a control terminal that is connected to each load cell in the load cell array via a power cable and a signal cable, such that the control terminal supplies power to the load cells via the power cable and receives signals from the load cells via the signal cable; the control terminal comprising a cable monitoring unit, such that the control terminal determines the respective states of the power cable and the signal cable, based on the external information collected by the collection device and a detection signal of the cable monitoring unit.

8. The weighing network of claim 7, wherein the signals of the load cells received by the control terminal via the signal cable comprise a load stress value Fₙ and a state information matrix Sₜ for each load cell.

9. The weighing network of claim 8, wherein:
the external information comprises an arrangement position, the type of a weighted object and time information for each load cell in the load cell array; and
the control terminal establishes a weighing process database in combination with the external information, and the load stress value Fₙ and the state information matrix Sₜ for each load cell.

10. A method for monitoring a weighing network, comprising the steps of:
collecting, in the control terminal of a weighing network having the properties of claim 8, real-time external information, a real-time load stress value Fₙ and a real-time state information matrix Sₜ for each load cell; and
comparing the real-time external information, and the real-time load stress value Fₙ and the real-time state information matrix Sₜ for each load cell with data stored in a weighing process database to monitor the state of the weighing network.
